(19) United States
(12) Patent Application Publication
(10) Pub. No.: US 2017/0374265 A1
(43) Pub. Date: Dec. 28, 2017

(54) SYSTEMS AND METHODS FOR TIME SYNCHED HIGH SPEED FLASH

(71) Applicant: QUALCOMM Incorporated, San Diego, CA (US)

(72) Inventor: Keir Finlow-Bates, Kangasala (FI)

(21) Appl. No.: 15/189,334

(22) Filed: Jun. 22, 2016

(51) Int. Cl. H04N 5/232; G01S 19/14; H04N 5/06; H04N 5/235

(52) U.S. Cl. CPC H04N 5/23203; H04N 5/2354; G01S 19/14; H04N 5/06

(57) ABSTRACT

Systems and methods are disclosed for remotely activating a flash at a determined time, where a camera and a flash are temporally synchronized using a time signal received from a GPS satellite. One embodiment includes a system having a camera that includes an image sensor, a GPS receiver configured to receive time information, a processor configured to determine an image capture time t₁ for capturing the image of the scene, the image capture time t₁ being a time indicative of a time derived from time information received from the GPS satellite, and a camera communication module configured to wirelessly communicate with an illumination system to transmit flash information to the illumination system, the flash information including the image capture time t₁, and capture an image of the scene with the camera at the image capture time t₁.

### BACKGROUND OF THE INVENTION

### Field of the Invention

This disclosure relates to capturing images and, more particularly, communication and timing between an imaging device and an illumination device.

### Description of the Related Art

Camera and illumination devices (or flashes) are used for illuminating and capturing a still scene, or video of a scene. Typically, the camera and the illumination device operate by synchronizing their respective functions using an electrical signal applied to a wired connection between the camera and the illumination device, or by using a radio synch system that sends a wireless signal to the illumination device to activate the flash. However, there are often times when it would be advantageous to have the illumination device set at a distance.

Using remote lighting when photographing a scene can be difficult, especially for outdoor shots. For example, photographing a building or other outdoor scene using flashes may present a significant synchronization challenges when the flashes are positioned close to the scene and the camera is set-up further away, for example, to capture an entire building. In certain situations, using wires (cables) for remote photography lighting may be impractical or cumbersome. If wires are used they must be arranged to be out-of-sight in the scene. As a result of these difficulties, various remote control devices utilizing wireless technologies have been developed to remotely control flashes. However, timing and communication problems can arise with these devices when flash actuation signals are sent wirelessly due to communication latency and physical environment issues.

External illumination devices are often preferred in some aspects of photography, and thus require timing of the illumination device and the camera to be synchronized in order to function properly. Separating a camera and a flash, and communicating the timing of their respective functions via wireless communication allows a user to capture images of a scene without being bound by the limitations of a wired configuration. Such systems must address delays that may occur in communication from a camera to a remote flash unit, and processing delays within the camera. For example, many cameras that include processors running ancillary software may experience a processing delay. Such delays prevent the camera from capturing an image immediately after the user has actuated the shutter release. Accordingly, improved systems and methods for accurately synchronizing timing between an illumination device and a camera are desirable.

### SUMMARY OF THE INVENTION

A summary of sample aspects of the disclosure follows. For convenience, one or more aspects of the disclosure may be referred to herein simply as “some aspects.”

Methods and apparatuses or devices being disclosed herein each have several aspects, no single one of which is solely responsible for its desirable attributes. Without limiting the scope of this disclosure, for example, as expressed by the claims which follow, its more prominent features will now be discussed briefly.

One innovation includes a system including a camera having an image sensor, a global positioning system (GPS) receiver configured to receive time information from a GPS satellite, a processor in communication to a memory component having instructions stored thereon to configure the processor to determine an image capture time t₁ for capturing the image of the scene, the image capture time t₁ being a time indicative of a time derived from time information received from the GPS satellite, and a camera communication module configured to wirelessly communicate with an illumination system to transmit flash information to the illumination system, the flash information including the image capture time t₁, and further configure the processor to capture an image of the scene with the camera at the image capture time t₁.

In some embodiments, the illumination system includes a light source, a GPS receiver configured to receive time information from a GPS satellite, a communication module configured to wirelessly communicate with the camera to receive the flash information including the image capture time t₁, and a processor in communication to a memory component having instructions stored thereon to configure the processor to activate the light source at the image capture time t₁ using time information received from a GPS satellite to determine when the image capture time t₁ occurs.

In some embodiments, the camera communication module is further configured to receive an acknowledgment message from the illumination system, wherein the acknowledgment message provides at least one of: an acceptance of the image capture time or a denial of the image capture time. In some embodiments, the acknowledgement message provides a denial of the image capture time t₁ and a reason for the denial of the image capture time t₁. In some embodiments, the processor is configured to determine the image capture time t₁ by including a latency time period. In some embodiments, the latency time period indicates a length of time elapsed between transmission of the flash information from the camera and the receipt of the flash information by the illumination device. In some embodiments, the latency time period indicates a length of time between the generation of the flash information and the receipt of the flash information by the illumination device. For some embodiments, the latency time period is determined based on at least one of: a time that a software interrupt can occur as determined by the processor, and a communication delay between the camera system and the flash. In some embodiments, the flash information includes a shutter speed. In some embodiments, the processor is further configured to generate a GPS clock cycle for tracking image capture time t₁, wherein one cycle of the GPS clock cycle is equivalent to a duration of time between two sequentially received frames of time information from the GPS satellite.

Another innovation is a method for illuminating and capturing an image of a scene using a camera device, the camera device wirelessly paired to a flash for wireless communication, comprising, receiving a frame of time information via a global positioning system (GPS) receiver, the frame of time information transmitted from a GPS satellite, determining an image capture time for capturing an image of a scene, the image capture time based on the received time information, transmitting a first message to the flash, the first message comprising the image capture time, and capturing the image of the image of the scene at the image capture time.

In some embodiments, the flash comprises receiving the frame of time information via the GPS receiver, the frame of time information transmitted from the GPS satellite, receiving the flash information including the image capture time t₁ from the camera device, activating a light source at the image capture time t₁ using time information received from the GPS satellite to determine when the image capture time t₁ occurs. In some embodiments, the camera device is further configured to receive an acknowledgment message from the flash. In some embodiments, the acknowledgment message provides at least one of an acceptance of the image capture time t₁, or a denial of the image capture time. In some embodiments, the acknowledgement message provides a denial of the image capture time t₁ and a reason for the denial of the image capture time t₁. In some embodiments, determining the image capture time t₁ includes a latency time period. In some embodiments, the latency time period is determined based on at least one of a time that a software interrupt can occur as determined by a processor, and a communication delay between the camera system and the flash.

Another innovation is a system for capturing an image of a scene, comprising a means for capturing the image of the scene at an image capture time, means for illuminating the scene, wherein the means for illuminating is wirelessly paired to the means for capturing the image, means for receiving a frame of time information transmitted from a global positioning system (GPS) satellite, means for determining the image capture time based on the received time information, and means for transmitting a first message to the means for illuminating, the first message comprising the image capture time. For some embodiments, the means for illuminating further comprises means for receiving the frame of time information transmitted from the GPS satellite, means for receiving the image capture time t₁, means for activating a light source at the image capture time t₁ using time information received from the GPS satellite to determine when the image capture time t₁ occurs. For some embodiments, the image capture time t₁ includes a latency time period. For some embodiments, the latency time period is determined based on at least one of a time that a software interrupt can occur as determined by a processor, and a communication delay between the camera system and the flash.

### BRIEF DESCRIPTION OF THE DRAWINGS

FIG. 1 is a block diagram illustrating an example of an illumination system (also referred as a “flash” for ease of reference) that may be configured to wirelessly communicate with a camera and to illuminate a scene to be captured by the camera.

FIG. 2 is a block diagram illustrating an example of an embodiment of a flash configured to communicate with an imaging system (also referred to as a “camera” for ease of reference).

FIG. 3 is a block diagram illustrating an example of an embodiment of an imaging system configured to communicate with an illumination device.

FIG. 4A is a diagram illustrating a configuration of a navigation message transmitted from a GPS satellite.

FIG. 4B is a diagram illustrating an example of data that may be included in a packet sent from a GPS device, which is received by a GPS receiver in communication with, or included in, in a camera or a flash.

FIG. 5 is a timing diagram illustrating an example range of time for generating an image capture time, transmitting the image capture time to a flash, and activating the flash.

FIG. 6 is a timing diagram illustrating an example of an embodiment of a camera that is configured to determine an image capture time.

FIG. 7 is a timing diagram illustrating an example of an embodiment of a flash configured to determine a time to activate a light source.

FIG. 8 is a flow chart that illustrates an example process for determining an image capture time and transmitting the image capture time from a camera to a flash.

FIG. 9 is a block diagram illustrating an example of an apparatus for generating an image capture time and transmitting the image capture time to a flash.

### DETAILED DESCRIPTION OF THE PREFERRED EMBODIMENT

The following detailed description is directed to certain specific embodiments of the invention. However, the invention can be embodied in a multitude of different ways. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to, or other than one or more of the aspects set forth herein.

The examples, systems, and methods described herein are described with respect to techniques for synchronizing camera and an illumination device (or “flash”) 200. The systems and methods described herein may be implemented on various types of imaging systems that include a camera and operate in conjunction with various types of illumination systems that include a light source to light an object or a scene. These include general purpose or special purpose digital cameras, film cameras, or any camera attached to or integrated with an electronic or analog system. Examples of photosensitive devices or cameras that may be suitable for use with the invention include, but are not limited to, semiconductor charge-coupled devices (CCD) or active sensors in CMOS or N-Type metal-oxide-semiconductor (NMOS) technologies, all of which can be germane in a variety of applications including: digital cameras, hand-held or laptop devices, and mobile devices (e.g., phones, smart phones, Personal Data Assistants (PDAs), Ultra Mobile Personal Computers (UMPCs), and Mobile Internet Devices (MIDs)). Examples of light sources that may be included in the illuminating devices and that may be suitable for use with the invention include, but are not limited to, flash lamps, flashbulbs, electronic flashes, high speed flash, multi-flash, LED flash, and the electronic and mechanical systems associated with a illumination device.

Camera and Illumination System

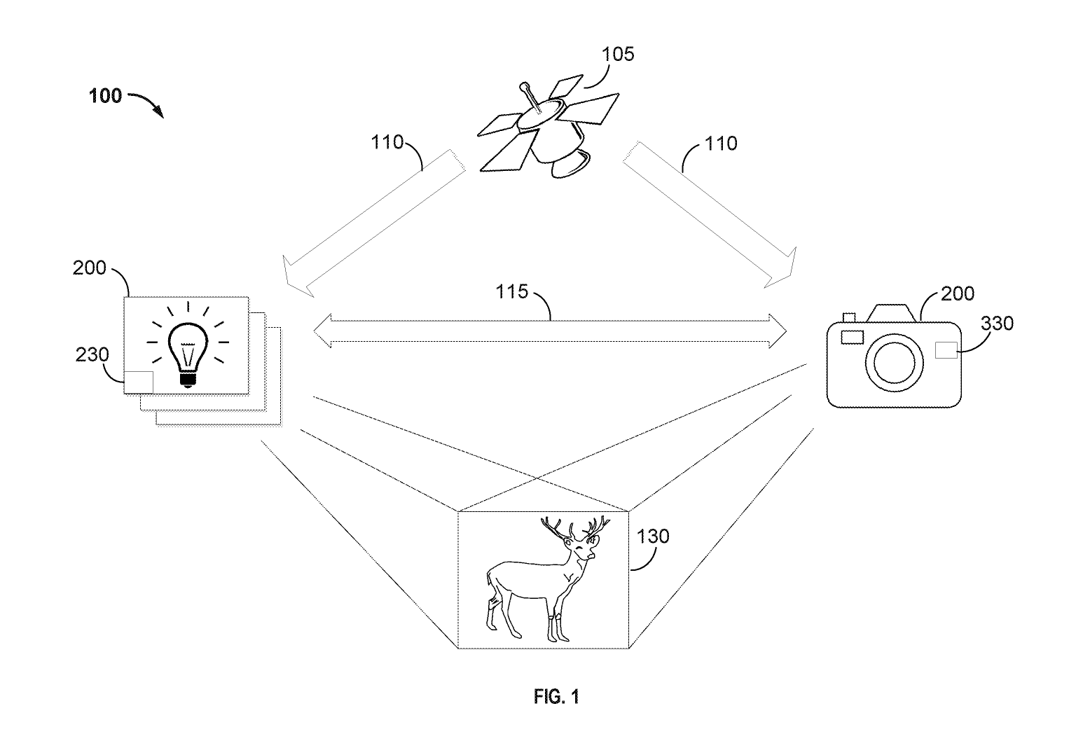

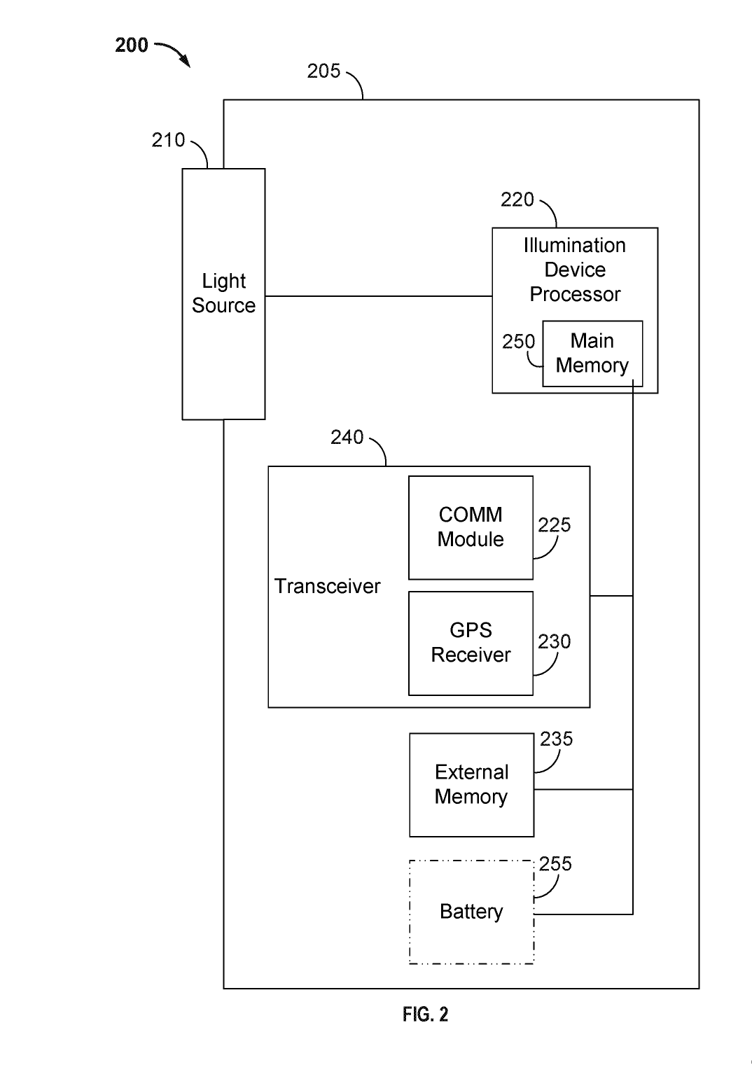

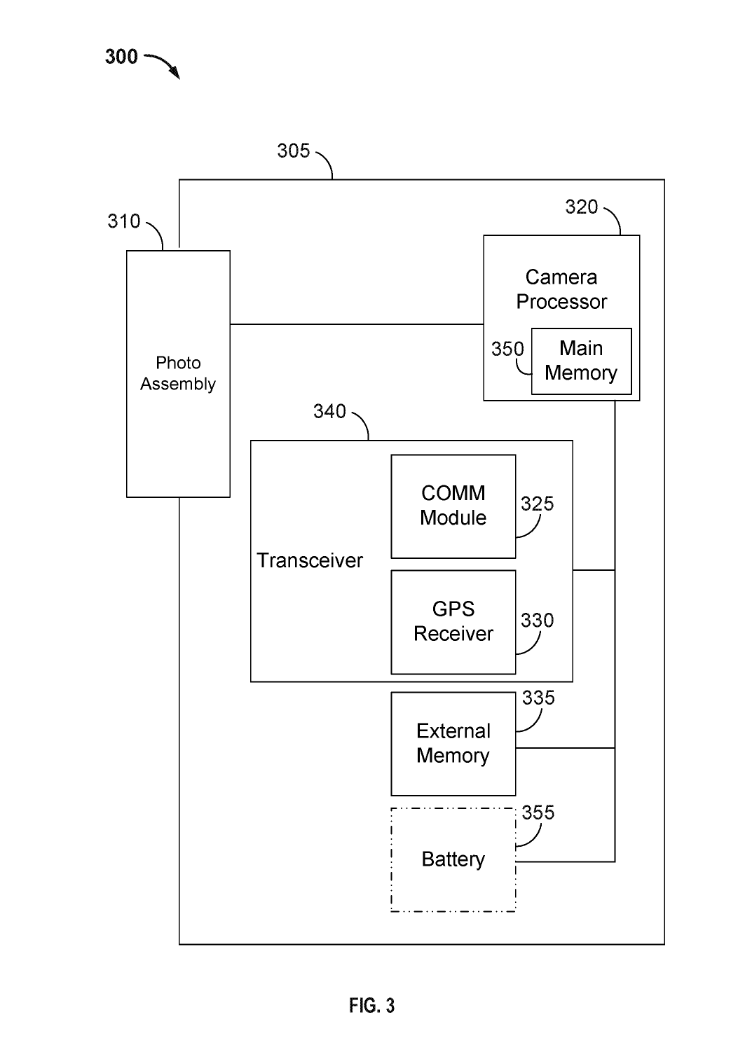

FIG. 1 illustrates an example of a system 100 for providing flash actuation information from an imaging system 300 (which may also be referred to for ease of reference as “camera 300”) to a remotely located flash 200 (which may also be referred to herein for ease of reference as “flash 200”) to illuminate a scene 130. As used herein, “remotely located” refers to a position of the flash 200 that is not physically (structurally) attached to the camera 300 or incorporated in the camera 300 (e.g., such that the camera 300 structurally supports the flash 200). The camera 300 and the flash 200 are configured to receive signals from a timing signal provider, which in the examples described herein is a Global Positioning System (GPS) satellite 105. In other embodiments, the system could include a different timing signal provider that provides at least timing information to the camera 300 and the flash 200, for example, a land-based signal provider such as a Wi-Fi transmitter or a cell tower. Components of the flash 200 are also described in reference to FIG. 2, and components of the camera 300 are further described in reference to FIG. 3.

In some example implementations, the system 100 includes at least one GPS satellite 105 (or NAVSTAR) that communicates to a GPS receiver 230 in the flash 200 and to a GPS receiver 330 in the camera 300. In other implementations, two or more GPS satellites 105 may be used for communicating GPS information to the GPS receivers 230, 330 for determining position data of either or both of the flash 200 and a camera 300. The GPS satellite 105 regularly provides, over radio waves, position and time data via signals 110, and such information can be received by GPS receivers 230, 330.

The flash 200 and the camera 300 are also configured to communicate information over a wireless communication link 115. The communication link 115 may be a direct or in-direct communication link between the camera 300 and the flash 200. In some embodiments, the communication link 115 may include one-way communication of information from the camera 300 to the flash 200. In other embodiments, the communication link 115 may include two-way communication between the flash 200 and the camera 300. The camera 300 and the flash 200 may include hardware (e.g., a processor, a transceiver) and a memory component with software thereon for causing the hardware to execute a process for using a communication link 115 that is based on a communication protocol, for example, for example, Bluetooth or Wi-Fi, or an infra-red (IR) beam communication protocol. In other embodiments, communication between the camera 300 and the flash 200 utilizes a communication link 115 that is based on a radio frequency protocol that has a range greater than about ten (10) meters, in other words, a range that is longer than what is typically achieved by Bluetooth communications, or in some embodiments a range a range that is longer than what is typically achieved by Wi-Fi. In some embodiments, several different communication protocols may be available for communication between the camera 300 and the flash 200 (for example, Bluetooth, Wi-Fi, IR, one or more of a particular configured radio frequency). In such cases, one of available communication protocols may be selected by a user, may be automatically suggested to the user by the camera 200, and/or be automatically selected by the camera 300, based on, for example, the distance between the flash 200 and the camera 300. In some embodiments, the camera 300 uses GPS signal 110 to determine its location, and uses the communication link 115 to receive information from the flash 200 relating to its location, and then determines a suitable communication protocol that can be used for the distance between the camera 300 and the flash 200.

In one example of the operations of the system illustrated in FIG. 1, the camera 300 determines at least one time t₁ in the future (e.g., by one or more tenths of a second, or one or more seconds) to activate the flash 200 and when the camera 300 will capture an image, and communicate that time t₁ to the flash 200, directly or indirectly, using the communication link 115. In some embodiments, the flash 200 may receive the time t₁ and when time t₁ occurs, the flash 200 will provide illumination. In some embodiments, the flash 200 may receive a time t₁ and then calculate the time a light source of the flash 200 needs to begin to be activated such that the light source reaches its desired illumination at time t₁ when the camera 300 captures an image of a scene 130. In another embodiment, utilizing the camera 300, a user may adjust a setting of the flash 200 so that the flash 200 provides illumination at a lesser degree of intensity than full power when the image is captured, or provides a different mode of flash (e.g., two or more flashes of light at a certain time duration or intensity).

The flash 200 referred to herein may, in some embodiments, be in reference to one or more flash 200 devices, which may be independent or which may communicate with each other. For example, one flash 200 may be in communication with the camera 300 and one or more other flashes maybe in communication with the flash 200, and receive information on when to provide illumination from the flash 200, but not be in communication with the camera 300. In some embodiments, the camera 300 may communicate 115 with multiple flash 200 devices at the same time, or at different times, to provide them times to provide illumination.

The GPS receivers 230, 330 provide a synchronized time to the flash 200 and camera 300, respectively, using time information provided by the GPS signals 110. The GPS satellites 105 transmit, as part of their message, satellite positioning data (ephemeris data), and clock timing data (GPS time). In addition, the satellites transmit time-of-week (TOW) information associated with the satellite signal 110, which allows the GPS receivers 230, 330 to unambiguously determine local time.

### Flash 200

FIG. 2 illustrates an example of components in an embodiment of the flash 200. The flash 200 may include a housing 205 or cover containing the flash 200 system. The flash 200 system may include one or more of a light source 210, a processor 220, a communication (COMM) module 225 and a COMM module transceiver circuit 240, a GPS receiver 230, and an optional battery 255. The housing 205 may include receptacles for one or more outlets for connecting the flash 200 to a peripheral object, electronic device, or power source. For example, the housing 205 may include an outlet for connecting a USB cable to the flash 200. The housing 205 may include any material suitable for containing the flash 200 system. The housing 205, which may sometimes be referred to as an enclosure or case, may be formed of plastic, glass, ceramics, carbon-fiber materials and other fiber composites, metal (e.g., stainless steel, aluminum), other suitable materials, or a combination of any two or more of these materials. The light source 210 may be connected to the processor 220 which activates the light source 210 either directly or indirectly. The processor 220 may be connected to both the COMM module 225 and the GPS receiver 230. In this configuration, the processor 220 may receive data from the GPS receiver 230, and relay the data to the COMM module 225 and control the operation of the COMM module 225.

As illustrated in FIG. 2, the flash 200 may include a battery 255. The battery 255 may be a removable or a permanent rechargeable fixture in the flash 200. The battery 255 may provide power to the hardware and light source 210 of the flash 200. The battery 255 may be used to charge a capacitor that is then discharged into the light source 210 to initiate a flash of light. The flash 200 may also include a capability for a wired power. For example, the flash 200 may include receptacles for one or more outlets for connecting the flash 200 to another electronic device that can provide power, or to a mains power source. For example, the housing 205 may include an outlet for connecting a USB cable or other means of providing power, or a hot shoe mount.

Still referring to FIG. 2, the transceiver circuit 240 may include a wireless communication (“COMM”) module 225 and a GPS receiver 230. The transceiver circuit 240 may be configured to transmit and receive wireless communication signals to peripheral devices. The signals may be transmitted via wireless connectivity technologies including, but not limited to, Wi-Fi, Li-Fi, Zigbee, Bluetooth, Zwave, or cellular connections. The transceiver circuit 240 may also be configured to receive GPS signals 110. In the configuration illustrated in FIG. 3, the processor 220 may control the data communicated from the COMM module 225, and may receive the data communicated to the COMM module 225. In another embodiment, the COMM module 225 may be physically integrated with a peripheral device using wired connectivity technologies. The COMM module 225 may be part of a transceiver circuit 240. In one embodiment, the transceiver circuit 240 receives radio waves at a specific frequency. As illustrated, the COMM module 225 may interpret or “decode” the incoming signals over the communication link 115 and send them to other parts of the flash 200 for additional processing. For example, where the flash 200 and the camera 300 communicate using RF signals such as Bluetooth signals over the communication link 115, the COMM module 225 may transmit and receive the Bluetooth formatted signals via the transceiver circuit 240 and translate the Bluetooth signals into a different format readable by the processor 220. In another example, the COMM module 225 may receive information from the processor 220, the external memory 235, the GPS receiver 230, or all three, and determine from the information a signal that can be transmitted from the flash transceiver circuit 240 to the camera transceiver 340 (FIG. 3).

Still referring to FIG. 2, the GPS receiver 230 may be a single channel or multi-channel receiver. A single channel receiver can provide an accurate time which is of primary concern. A multi-channel receiver can provide both an accurate time and accurate location associated with the time. The functionality of both the single channel and the multi-channel are discussed below in more detail. The GPS receiver 230 may be integrated with the processor 220 and transceiver circuit 240, allowing the GPS receiver 230 to provide time and location data to the processor 220. The processor 220 may manipulate and direct the data received by the GPS receiver 230 to the COMM module 225 which can transmit the data over a wired or wireless connection.

As illustrated in FIG. 2, the processor 220 is in communication with the light source to control the light source 210 operation and can communicate with the COMM module 225 and the GPS receiver 230. The processor 220 may be integrated with a memory 235 for storing GPS time data, GPS location data, information regarding other devices the COMM module 225 communicates with, different flash modes, and user configuration information. The flash device 200 may be configured to use different flash modes, including but not limited to, a red eye reduction mode, a fill flash mode, a slow synch flash, a rear curtain synch mode, a repeating flash or strobe mode, and a flash EV compensation mode.

The external memory 235 may also store information regarding the type of film used in a camera 300, for example but not limited to, shutter speed, focal ratio, the type of image processor, the type of image sensor, type of auto focus, and average delay in time between the user pressing a button to take a picture and the picture being taken. In one embodiment, the external memory 235 may be a fixed piece of hardware such as a random access memory (RAM) chip, a read-only memory, and a flash memory. In another embodiment, the external memory 235 may include a removable memory device, for example, a memory card and a USB drive. The processor 220 may include an additional memory, or “main memory” 250 integrated with the processor hardware and directly accessibly by the processor 220. The main memory 250 may be a random access memory (RAM) chip, a read-only memory, or a flash memory, and may contain instructions for the processor 220 to interface with the light source 210, the COMM module 225, the GPS receiver 230, and the external memory 235.

The processor 220 may control the light source 210 based on the time provided by the GPS receiver 230 and a GPS time of another device received by the COMM module 225. The light source 210 may include electronic circuitry for charging a capacitor with electrical energy. In one embodiment, the processor may receive a time from a GPS receiver 230 of another device and compare that time to the GPS receiver 230 of the same device. The processor 220 may identify the received time as a future image capture time, at which point the processor 220 may activate the light source 210. The processor 220, upon reading a match between the image capture time received by the other device and a time received from the GPS receiver 230, may discharge the energy stored in the capacitor, causing the light source 210 to illuminate the scene. In another embodiment, the processor 220 may receive (via the COMM module 225 and transceiver circuit 240) times from a plurality of other devices, and activate the light source 210 at each of those times.

In one example embodiment, the flash 200 may include an operating system (OS) that manages hardware and software resources of the flash 200 and provides common services for executable programs running or stored in a main memory 250 or other external memory 235 integrated with the flash 200. The OS may be a component of the software on the flash 200. Time-sharing operating systems may schedule tasks for efficient use of the flash 200 and may also include accounting software for cost allocation of processor time, mass storage, printing, and other resources. For hardware functions such as input and output and memory allocation, the OS may act as an intermediary between the executable programs and the flash 200 hardware. The program code may be executed directly by the hardware, however the OS function may interrupt it. The OS may include, but is not limited to, an Apple OS, Linux and its variants, and Microsoft Windows. The OS may also include mobile operating systems such as Android and iOS.

In one example embodiment, the flash 200 may include an interrupt mechanism for the OS. Interrupts may be allocated one of a number of different interrupt levels, for example eight, where 0 is the highest level and 7 is the lowest level. For example, when the flash 200 receives a wireless message over a communication link 115 containing an image capture time from the camera 300, the processor may suspend whatever program is running, save its status, and execute instructions to activate the light source 210 at the capture time. In preparation to activate the light source 210, the flash 200 may use to a received GPS time.

Still referring to FIG. 2, the light source 210 may be integrated with a processor 220 that controls activation and power to the light source 210. The type of light source 210 may include, but is not limited to: flash lamps, flashbulbs, electronic flashes, high speed flash, multi-flash, and LED flashes. The light source 210 may include a housing that includes a metal coating or other opaque or reflective coating. The reflective coating or material may guide the light in a particular direction and to reduce stray light. The housing, which may sometimes be referred to as an enclosure or case, may be formed of plastic, glass, ceramics, carbon-fiber materials and other fiber composites, metal (e.g., stainless steel, aluminum), other suitable materials, or a combination of any two or more of these materials. The housing may be formed using a uni-body configuration in which some or all of housing is machined or molded as a single structure or may be formed using multiple structures (e.g., an internal frame structure, one or more structures that form exterior housing surfaces).

### Camera

FIG. 3 illustrates an example embodiment of a camera 300. The camera 300 may include a housing 305 or cover containing the camera 300 system. The housing 305, which may sometimes be referred to as an enclosure or case, may be formed of plastic, glass, ceramics, carbon-fiber materials and other fiber composites, metal (e.g., stainless steel, aluminum), other suitable materials, or a combination of any two or more of these materials. The camera 300 system may include one or more of a photo assembly 310, a transceiver circuit 340, a processor 320, a communication (COMM) module 325, a global positioning system (GPS) receiver 330, and other objects included in a camera 300. The housing 305 may include receptacles for one or more outlets for connecting the camera 300 to a peripheral object or electronic device. For example, the housing 305 may include a receptacle for an outlet allowing connection of a USB cable to the camera 300. The housing 305 may include any material suitable for containing the camera 300. The photo assembly 310 may be connected to the processor 320 which activates the photo assembly 310 either directly or indirectly. The processor 320 may be connected to both the COMM module 325 and the GPS receiver 330. In this configuration, the processor 320 may receive data from the GPS receiver 330, and relay the data to the COMM module 325 and control the operation of the COMM module 325.

Still referring to FIG. 3, the camera 300 may include an optional battery 355. The battery 355 may be a removable or a permanent rechargeable fixture in the camera 300. The battery 355 may provide power to the hardware of the camera 300. The battery 355 may be used to charge a capacitor that is then discharged into the light source 210 of the flash 200 to initiate a flash of light. The camera 300 may also include a capability for a wired power source. For example, the camera 300 may include receptacles for one or more outlets for connecting the camera 300 to another electronic device that can provide power, or to a mains power source. For example, the housing 305 may include a receptacle for an outlet allowing connection of a USB cable or other means of providing power, or a hot shoe mount.

Notably, various aspects of the techniques may be implemented by a portable device, including a wireless cellular handset, which is often referred to as a cellular or mobile phone. Other portable devices that may implement the various aspects of the techniques include so-called “smart phones,” extremely portable computing devices referred to as “netbooks,” laptop computers, portable media players (PMPs), and personal digital assistants (PDAs). The techniques may also be implemented by generally non-portable devices, such as desktop computers, set-top boxes (STBs), workstations, video playback devices (e.g., a digital video disc or DVD player), 2D display devices and 3D display devices, digital cameras, film cameras, or any other device that allows a user to control a camera operation. Thus, while described in this disclosure with respect to a mobile or portable camera 300, the various aspects of the techniques may be implemented by any computing device capable of capturing images.

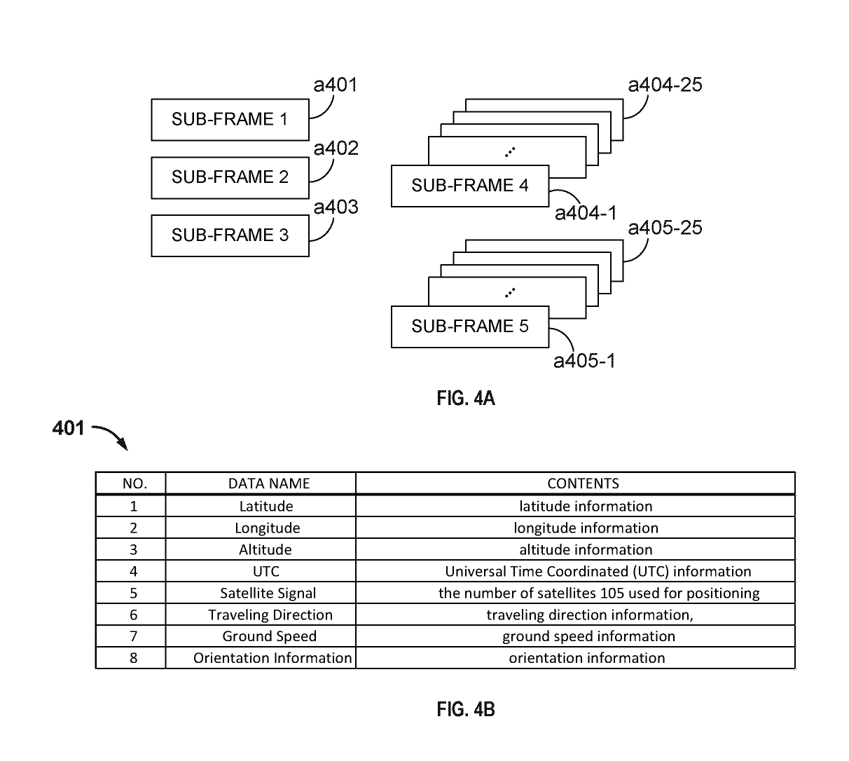

As illustrated in FIG. 3, the COMM module 325 may include a wireless communication assembly that allows the camera 300 to send and receive wireless communication signals to peripheral devices over a transceiver circuit 340. The signals may be transmitted via wireless connectivity technologies including, but not limited to, Wi-Fi, Li-Fi, Zigbee, Bluetooth, Zwave, or cellular connections. In the configuration illustrated in FIG. 4, the processor 320 may control the data communicated from the COMM module 325, and may receive data communicated to the COMM module 325. The transceiver circuit 340 may include circuitry for both a transmitter and a receiver. In another embodiment, the COMM module may be integrated with a peripheral device using wired connectivity technologies. The COMM module 325 may be part of the transceiver circuit 340. In one embodiment, the transceiver circuit 340 receives radio waves at a specific frequency. The COMM module 325 may interpret or “decode” the incoming signals over the communication link 115 and send them to other parts of the camera 300 for additional processing. For example, where the flash 200 and the camera 300 communicate using Bluetooth signals over the communication link 115, the COMM module 325 may transmit and receive the Bluetooth formatted signals via the transceiver circuit 340 and translate the Bluetooth signals into a different format readable by the processor 320. In another example, the COMM module 325 may receive information from the processor 320, the external memory 335, the GPS receiver 330, or all three, and translate the information into a signal that can be transmitted to, and received by, the camera 300 over the transceiver circuit (240, 340).

Still referring to FIG. 3, the GPS receiver 330 may be a single channel or multi-channel receiver. A single channel receiver can provide an accurate time which is of primary concern. A multi-channel receiver can provide both an accurate time and accurate location associated with the time. The functionality of both the single channel and the multi-channel are discussed below in more detail. The GPS receiver 330 is integrated with the processor 320, allowing the GPS receiver 330 to provide time and location data to the processor 320. This allows the processor to manipulate and direct the data received by the GPS receiver 330 to the COMM module 325 which can transmit the data over a wired or wireless connection.

Still referring to FIG. 3, the processor 320 can control the photo assembly 310 operation and can communicate with the COMM module 325 and the GPS receiver 330. The processor 320 may also include an external memory 335 for storing GPS time data, GPS location data, information regarding other devices the COMM module 325 communicates with, different photo assembly 310 modes, and user configuration information. The external memory 335 may also store information regarding the type flash used in a flash 200, the flash speed, the type of processor used on the flash, auto focus time of the camera 300, and the type of GPS receiver 230 of the flash 200. In one embodiment, the external memory 335 may be a fixed piece of hardware such as a random access memory (RAM) chip, a read-only memory, and a flash memory. In another embodiment, the external memory 335 may include a removable memory device, for example, a memory card and a USB drive. The processor 320 may include an additional memory, or “main memory” 350 integrated with the processor hardware and directly accessibly by the processor 320. The main memory 350 may be a random access memory (RAM) chip, a read-only memory, or a flash memory, and may contain instructions allowing the processor 320 to interface with the photo assembly 310, the COMM module 325, the GPS receiver 330, and the external memory 335.

In one example embodiment, the camera device may include an operating system (OS) that manages hardware and software resources of the camera 300 and provides common services for executable programs running or stored on the camera 300. The operating system may be a component of the software on the camera 300. Time-sharing operating systems may schedule tasks for efficient use of the camera 300 and may also include accounting software for cost allocation of processor time, mass storage, printing, and other resources. For hardware functions such as input and output and memory allocation, the operating system may act as an intermediary between the executable programs and the camera 300 hardware. The program code may be executed directly by the hardware, however the OS function may interrupt it. The OS may include, but is not limited to, an Apple OS, Linux and its variants, and Microsoft Windows. The OS may also include mobile operating systems such as Android and iOS.

In one example embodiment, the camera 300 may include an interrupt mechanism for the OS. Interrupts may be allocated one of a number of different interrupt levels, for example eight, where 0 is the highest level and 7 is the lowest level. For example, when a user actuates the shutter release on the camera 300, the processor 320 may suspend whatever program is currently running, save it's status, and run a camera function associated with actuation of the shutter release. In one example, upon a user actuating the shutter release, the processor 320 suspends whatever program is running, saves it's status, determines an image capture time, then wirelessly sends a message over a communication link 115 to the flash 200 before capturing an image at the determined time, the message over a communication link 115 containing the image capture time.

As illustrated in FIG. 3, the photo assembly 310 may include an electronic image sensor to capture an image. The electronic image sensor may include a charge coupled device (CCD) or a complementary metal oxide semiconductor (CMOS) sensor. The image sensor includes an array of pixels. Each pixel in the array includes at least a photosensitive element for outputting a signal having a magnitude proportional to the intensity of incident light or radiation contacting the photosensitive element. When exposed to incident light reflected or emitted from a scene, each pixel in the array outputs a signal having a magnitude corresponding to an intensity of light at one point in the scene. The signals output from each photosensitive element may be processed to form an image representing the captured scene. Filters for use with image sensors include materials configured to block out certain wavelengths of radiation. To capture color images, photo sensitive elements should be able to separately detect wavelengths of light associated with different colors. For example, a photo sensor may be designed to detect first, second, and third colors (e.g., red, green and blue wavelengths). To accomplish this, each pixel in the array of pixels may be covered with a single color filter (e.g., a red, green or blue filter) or with a plurality of color filters. The color filters may be arranged into a pattern to form a color filter array over the array of pixels such that each individual filter in the color filter array is aligned with one individual pixel in the array. Accordingly, each pixel in the array may detect the color of light corresponding to the filter(s) aligned with it.

The photo assembly 310 may also include a lens. The lens of a camera captures the light from the subject and brings it to a focus on the electrical sensor or film. In general terms, the two main optical parameters of a photographic lens are maximum aperture and focal length. The focal length determines the angle of view, and the size of the image relative to that of the object (subject) for a given distance to the subject (subject-distance). The maximum aperture (f-number, or f-stop) limits the brightness of the image and the fastest shutter speed usable for a given setting (focal length/effective aperture), with a smaller number indicating that more light is provided to the focal plane which typically can be thought of as the face of the image sensor in a simple digital camera. In one form of typical simple lens (technically a lens having a single element) a single focal length is provided. In focusing a camera using a single focal length lens, the distance between lens and the focal plane is changed which results in altering the focal point where the photographic subject image is directed onto the focal plane. The lens may be of manual or auto focus (AF). The camera processor 320 may control the photo assembly exposure period. The processor 320 may also determine the exposure period based in part on the size of the aperture and the brightness of the scene.

Still referring to FIG. 3, the photo assembly 310 may be integrated into the camera 300 and may be controlled by the processor 320. The photo assembly 310 may include a lens, a shutter, and film or an electronic image sensor. The photo assembly may 310 may also include more than one of the lens, shutter, and film or an electronic image sensor.

The camera 300 and flash 200 can receive time information from one GPS satellite 105 to have synchronized times. In some embodiments, the camera 300 and flash 200 to determine their locations by calculating the time-difference between multiple satellite transmissions received at the respective GPS receivers 330, 230. The time-difference may be determined using the absolute time of transmission from each satellite that the receiver receives timing information from.

In one embodiment, both the flash 200 and the camera 300 include a GPS receiver 230, 330, respectively. In this configuration, both the flash 200 and the camera 300 can determine time using GPS signals 110. When the camera 300 is activated by a user, the processor 320 may determine a future time to capture an image of a scene 130 using the photo assembly 310. The future time may also be referred to as an image capture time or a light source 210 activation time. The processor 320 may direct the COMM module 325 to transmit the determined image capture time to the flash 200 using a transceiver circuit 340. The COMM module 225 of the flash 200 may receive the image capture time and communicate it to the processor 220. The processor 220 may determine a delta between the future image capture time provided by the camera, and the current time provided by the GPS receiver 230 to determine the correct moment to activate the light source 210 so that the camera 300 and the flash 200 work synchronously or at a user configured step time. For example, the user may configure the camera 300 to instruct the flash 200 to activate the light source 210 at a specific time before or during the opening of the camera shutter so that light from the light source 210 is only available during a portion of the time the camera 300 shutter is open.

In another embodiment, only one of the flash 200 and the camera 300 includes a GPS receiver. For example, where only the camera 300 includes a GPS receiver 330, the COMM module 325 may send the flash 200 a current time and a light source 210 activation time. The current time may be modified by the processor 320 to account for “latency,” for example, a time period representative of a delay in communication between the camera 300 and the flash 200, or a delay in processing (for example, between generating an activation time for the flash and sending flash information that includes the activation time to the flash 300. The processor 320 of the flash 200 may use its own clock to determine the activation time, using the difference between the transmitted current time and the transmitted light source 210 activation time. In another example, where only the flash 200 includes a GPS receiver 230, the flash 200 may synchronize timing with the camera 300 by transmitting a number of time values from the GPS receiver 230 in a series of steps (for example, one transmission every second). The processor 320 of the camera 300 may determine a latency time and use its internal clock function to determine an activation time that is in synch with the GPS receiver 230 time of the flash 200. In this way, the flash 200 may maintain the integrity of the time synchronized between the camera 300 by periodically transmitting the series of messages including the current GPS receiver 230 time.

In another embodiment, the camera 300 includes a GPS receiver 330 with more than one channel. In a multi-channel GPS receiver 330, the location and elevation of the camera 300 may be stored in the external memory 335 at the time the scene 130 is captured. The camera 300 may include the additional GPS information for each captured image.

### GPS Signals

A transmitted GPS signal 110 (FIG. 1) is a direct sequence spread spectrum signal. The commercial use GPS signal available associated with standard positioning service and utilizes a direct sequence bi-phase spreading signal with a 1.023 MHz spread rate placed upon a carrier at 1575.42 MHz (L1 frequency). Each GPS satellite 105 transmits a unique pseudo-random noise code (also referred to as the ‘Gold’ code) which identifies the particular satellite, and allows signals simultaneously transmitted from several satellites to be simultaneously received by a GPS receiver with little interference from one another. Superimposed on the 1.023 MHz PN code is low rate data at a 50 Hz rate. This 50 Hz signal is a binary phase shift keyed (BPSK) data stream with bit boundaries aligned with the beginning of a PN frame. The 50 Hz signal modulates the GPS signal 110 which consists of data bits which describe the GPS satellite orbits, clock corrections, time-of-week information, and other system parameters. In one example embodiment, the absolute time associated with the satellite transmissions are determined in the flash GPS receiver 230 and the camera GPS receiver 330 by reading data in the Navigation Message of the GPS signal. In the standard method of time determination, the flash and camera GPS receivers 230 330 decodes and synchronizes the 50 baud data bit stream. The 50 baud signal is arranged into 30-bit words grouped into subframes of 10 words, with a length of 300 bits and a duration of six seconds. Five subframes include a frame of 1500 bits and a duration of 30 seconds, and 25 frames include a superframe with a duration of 12.5 minutes.

FIG. 4A is a diagram illustrating a configuration of the GPS satellite signal 110. The GPS signal shown in FIG. 4A is illustrated as being received in five sets of sub-frames. Sub-frame 1 (a401) may include a state of each positioning satellite (for example, whether the satellite is functioning correctly), a clock correction coefficient which is a coefficient for correcting a clock error of the positioning satellite which is transmitted by the satellite, and the like. Sub-frame 2 (a402) may include orbit information (ephemeris data) of each positioning satellite. Sub-frame 3 (a403) may include orbit information (ephemeris data) of each positioning satellite. Sub-frame 4 (a404-1 to a404-25) may include an ionospheric delay correction coefficient which is a coefficient for correcting a signal received by the GPS receiver which is subject to delay by the ionosphere, UTC (Universal Time, Coordinated) relation information which is information indicating a relationship between the GPS time and the UTC, orbit information (almanac data) of all the positioning satellites, and the like. Sub-frame 5 (a405-1 to a405-25) is composed of orbit information (almanac data) of all the positioning satellites. In addition, information indicating the GPS time is included in the forefront of each sub-frame. GPS time is the time which is managed in the positioning satellite side in units of one week and is information expressed in the elapsed time from 0 o'clock every Sunday. The ephemeris data transmitted by the sub-frames 2 and 3 is composed of data of six elements of the orbit (longitude of ascending node, orbit inclination, argument of perigee, semi-major axis, eccentricity, and true anomaly) necessary for calculating the position of the positioning satellite, each correction value, time of epoch toe (ephemeris reference time) of the orbit, and the like. The ephemeris data is updated every two hours. In addition, the valid period of the ephemeris data is two hours±two hours.

GPS satellites provide global time via frequency dissemination (or GPS signals 110) 24 hours a day. The accuracy of the time provided by the GPS signals can be in the 100-nanosecond range. Referring to the components of the flash 200 (FIG. 2) and the camera 300 (FIG. 3), the transceiver circuits 240, 340 may receive GPS signals from one or more satellites 105. In one embodiment, the GPS receivers 230, 330 may include transceiver circuits 240, 340 for receiving the GPS signals 110 and a processor for interpreting the signals 110. Using the processors, the GPS receivers 230 330 may interpret or “decode” the received signals 110 and send them to other parts of the flash 200 or the camera 300 for additional processing. For example, the GPS receiver 330 of the camera 300 may receive the GPS signals 110 that are output from the GPS satellite 105 via a transceiver circuit 340 integrated with the GPS receiver 330. The processor of the GPS receiver 330 may translate the GPS signal 110 data into another format usable by the camera processor 320, the COMM module 325, and an external memory 335. For example, the GPS receiver 330 may generate first GPS information from the GPS signal 110, and output the first GPS information to the processor 320. The first GPS information is, for example, NMEA (National Marine Electronics Association) data having a communication protocol of a GPS receiver or the like which is prescribed by the NMEA. The processor 320 may store the first GPS information in the main memory or an external memory.

FIG. 4B illustrates an example configuration of the first GPS information. The processor 320 of the camera 300 may generate a message 401 that can be transmitted over a communication link 115. For example, the message 401 may be an American Standard Code for Information Interchange (ASCII) data format with GPS signal 110 information classified into specific content. The message 401 may include latitude information, longitude information, altitude information, UTC information, the number of GPS satellites 105 used for positioning, traveling direction information, ground speed information, and orientation information.

### Example Implementation

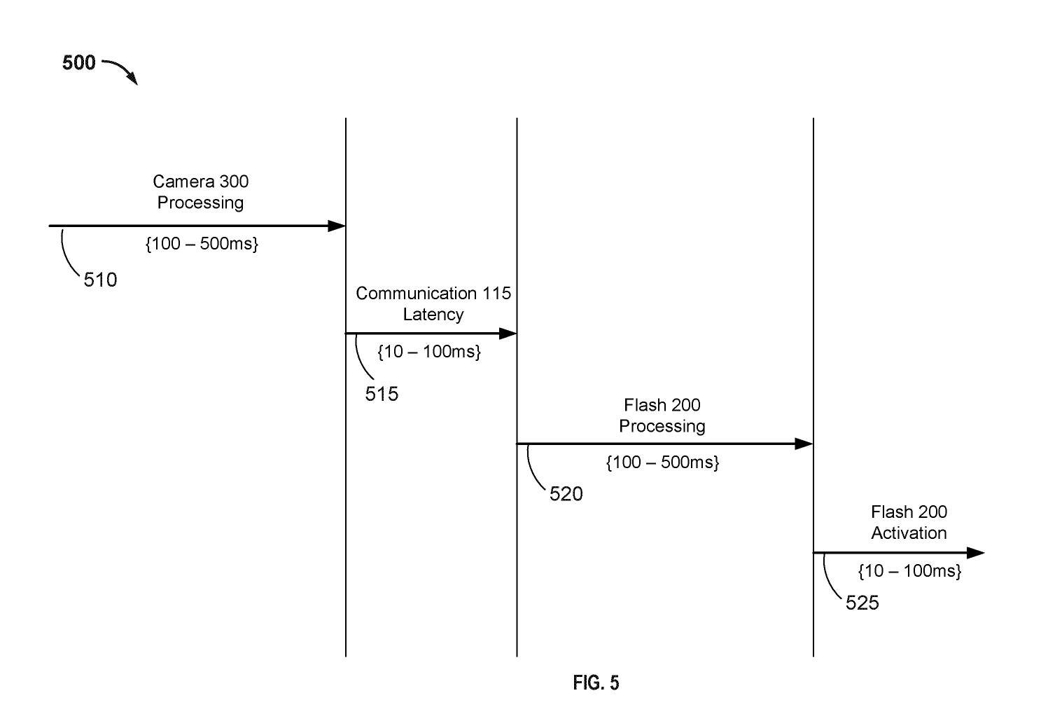

FIG. 5 illustrates an example timing diagram 500 for the determination of a future time for capturing an image and activating a light source 210 on the flash 200. In one example, the camera processor 320 determines a future time based on at least one of a camera processing time 510, a communication latency time 515, a flash 200 processing time 520, and a flash activation time 525. In one example, the camera processing time 510 may include determination of when a software interrupt can be executed to capture an image. The camera processing time 510 may also include an amount of time required to execute an auto focus function. The time required for the auto focus function may be estimated based on an average of times previously used to complete the auto focus function.

Still referring to FIG. 5, the communication latency time 515 may be determined by the camera processor 320. In one example, the camera 300 may utilize a “time of receipt” messaging sequence to determine a latency time. The camera 300 may transmit a first message to the flash 200, the first message containing a time stamp reflecting the GPS time at the point of first message transmittal. The flash device 200, upon receipt of the first message, may respond my transmitting a second message containing a GPS time that the first message was received by the flash 200. The camera processor 320 may then determine a communication latency time based on the time delta between transmission and receipt of the first message. In another example, the camera processor 320 may estimate a latency time based on the distance between the camera 300 and the flash 200. The distance may be determined based the GPS location of each of the camera 300 and the flash 200. In some aspects, determining the communication latency time 515 may also include determining the type of connection protocol being used by the camera 300 and the flash 200, such as an IEEE 802.11 protocol, a Bluetooth protocol, or another protocol, and determining a communication latency time 515, at least in part, on a maximum theoretical or a normal practical speed of that type of connection. For example, if a certain IEEE 802.11 protocol is used, the connection speed may be determined based upon a known speed for that type of IEEE 802.11 protocol. For example, if the IEEE 802.11ad protocol is used, the connection speed of this protocol may be determined based upon the known speeds of the protocol.

Still referring to FIG. 5, the flash processing speed 520 may be estimated by the camera processor 320. The flash processing speed 520 may be the amount of time required for the flash 200 to process the image capture time received by the camera 300. In one example, the flash processing speed 520 may be determined based on the amount of time required by the flash 200 to complete a digital handshake with the camera 300. In another example, the flash 200 may transmit a message to the camera 300 including at least one of a processing speed and/or a type of processor 220 found in the flash 200.

Still referring to FIG. 5, the flash activation time 525 may be used by the camera processor 320 to determine the image capture time, or future time. For example, the flash activation time 525 may be the time required for the flash 200 to actuate the light source 210 according to a flash mode. Different flash modes may require different amounts of time to be activated. In one example, the flash processor 220 determines the number of capacitors that will release a charge that will cause the light source 210 to illuminate the scene 130. The flash 200 may transmit to the camera 300 the amount of time required for a given flash mode.

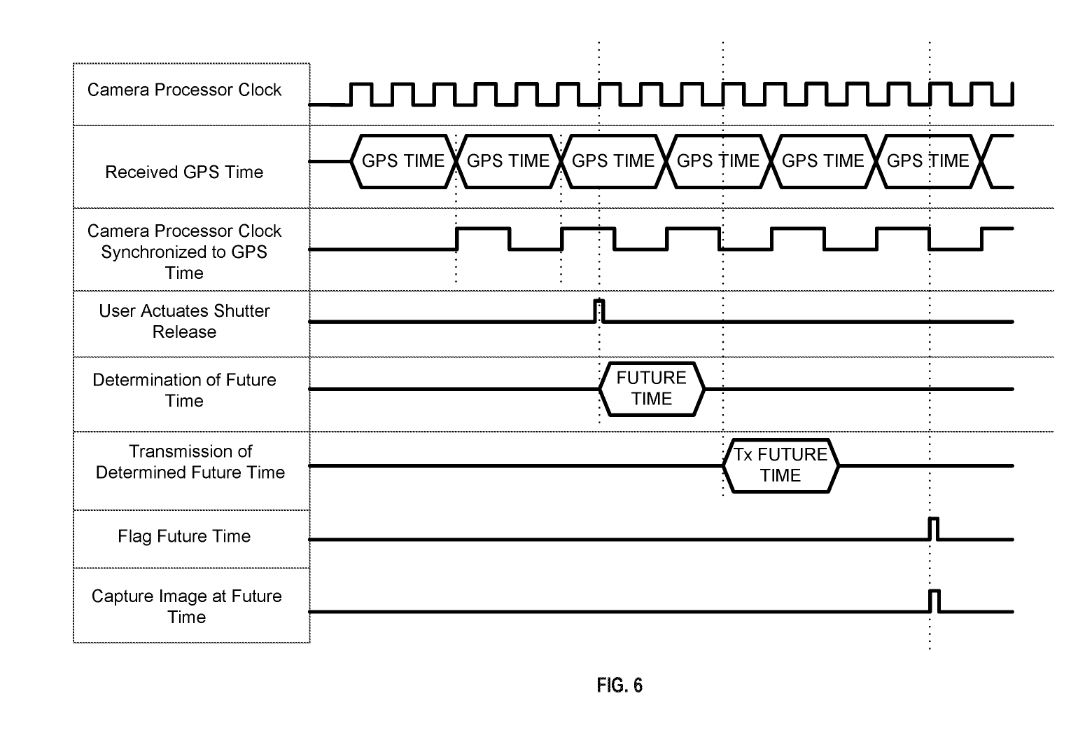

FIG. 6 illustrates an example timing diagram for the camera 300, according to some embodiments. FIG. 6 includes eight rows and is used as an example only. The first row is representative of the camera processor 320 clock cycle. The camera processor 320 clock cycle may be a signal that oscillates between an high and a low state that can coordinate actions of the camera 300. The clock signal may be produced by a clock generator such as a quartz piezo-electric oscillator. Although more complex arrangements may also be used, the clock signal may be in the form of a square wave with a 50% duty cycle with a fixed frequency. Circuits using the clock signal for synchronization may become active at either the rising edge, falling edge, or, in the case of double data rate, both in the rising and in the falling edges of the clock cycle. Such circuits may include the photo assembly 310, the main memory 350, the transceiver circuit 340, the COMM module 325, the GPS receiver 330, the external memory 335, and other circuits available on the camera 300.

Still referring to FIG. 6, the second row is representative of received GPS times. The GPS signal 110, as shown in FIG. 2A, is received in five sets of sub-frames. Information indicating the GPS time may be included in the forefront of each sub-frame, and may be deduced using the length of the Gold code in radio-wave space. For example, the GPS time can be determined by deducing the difference between transmission and arrival of the Gold code from the satellite. The gold code contains the time according to a satellite clock when the GPS signal 110 was transmitted. The camera processor 320 may generate a new clock cycle by calculating the time delta between two or more successive GPS times (i.e., times according to a satellite clock) received via the GPS signal 110. Receipt and interpretation of the GPS time from the GPS signal 110 may require more than one camera processor clock cycle. The third row is representative of a camera processor clock cycle that is synchronized with the received GPS time. The GPS time received by the GPS receivers (230, 330) can be substantially aligned with absolute time to an accuracy of approximately 30 ns. The camera processor 320 may adaptively adjust the GPS clock cycle based on the received GPS time to correct for any errors by storing previously received GPS times in the main memory 350 or the external memory 335 and comparing the previously received GPS times with GPS times received later to determine if the GPS clock cycle is accurate.

Still referring to FIG. 6, the fourth row is representative of a user actuated shutter release command. The shutter release command may be recognized at the rising edge of a camera processor 320 clock cycle, as illustrated, but may also be recognized at the falling edge of the clock cycle. Typically, the user actuated shutter release will trigger a logic signal voltage level to the camera processor 320. Any voltage between 0 and 1.8 volts may be considered a low logic state, and no shutter actuation is recognized in this range of voltages. Any voltage between 2 and 5 volts may be considered a high logic state, and the camera processor may recognize a voltage in this range as actuation of the shutter release. Upon actuation of the shutter release, the camera processor 320 will determine a future time. The future time is a time that will take place in the future, upon which the camera 300 will capture an image of the scene 130. The fifth row illustrates a determination of a future time by the camera processor 320. The determination of the future time may require a number of camera processor 320 clock cycles and may be initiated at the rising edge of a new camera processor 320 clock cycle that occurs during or follows immediately after actuation of the shutter release. It should be noted that the rising or falling edge may be used to initiate determination of the future time.

The sixth row of FIG. 6 illustrates the camera processor 320 initiating transmission of a message containing the determined future time. It should be noted that transmission of the future time may be initiated at the first rising or falling edge of the camera processor 320 clock cycle immediately following the determination of the future time. The message containing the future time may also include additional information or requests for information from the flash 200.

TABLE 1
Message Examples

| Value (Bit) | Description |
|---|---|
| 0001-0111 | Set flash mode |
| 1001 | Request flash power level |
| 1010 | Request flash GPS location |
| 1011 | Request flash communication protocol |
| 1100 | Request GPS satellite information |
| 1101 | Request flash “time of receipt” ACK message |
| 1110 | Set communication protocol |

Table 1 provides one example of a set of messages that the camera 300 may transmit to the flash 200 in addition to a future time. For example, the camera 300 may request GPS satellite information from the flash 200 relating to the identity of the satellite that the flash 200 is communicating with, to determine whether both the camera 300 and the flash 200 are communicating with the same satellite 105.

The camera processor 320 may provide the transceiver circuit 340 and COMM module 325 with the future time for wireless transmission to the flash 200. In one example embodiment, the flash 200 will send an acknowledgment message (ACK) to the camera 300, notifying the camera 300 that the future time was received. The ACK message may be, for example, a four-bit message transmitted in response to the future time message transmitted from the camera 300. The ACK message may also provide the camera 300 with additional information.

TABLE 2
ACK Message Examples

| Value (Bit) | Description |
|---|---|
| 0001 | Received and accepted |
| 0010 | Received and denied (no reason) |
| 0011 | Received and denied (Tx message received but |
| | containing error) |
| 0100 | Received and denied (Flash power low) |
| 0101 | Received and denied (Flash GPS receiver error) |
| 0110 | Received and denied (Flash light source error) |
| 0111 | Received and denied (new proposed time submitted) |
| 1000 | “Time of receipt” ACK message |

Table 2 provides one example of a set of ACK messages that the flash 200 may transmit to the camera 300 in response to a transmitted future time message from the camera 300. The flash 200 may include a GPS receiver, and may submit an ACK message that proposes a new time.

Still referring to FIG. 6, the seventh row illustrates a flag set by the camera processor indicating the future time. In one example, the future time may be established by a number of camera processor 320 clock cycles counted after actuation of the shutter release, as defined by the determination of the future time. In another example, the future time may be established by a number of GPS clock cycles. The future time flag may also be set according to a new proposed time provided by the flash 200. Upon reaching the clock cycle that corresponds to the flagged future time, the camera processor 320 may command the photo assembly 310 to capture an image of the scene. It should be noted that the photo assembly may have already been activated for auto focus and image preview purposes.

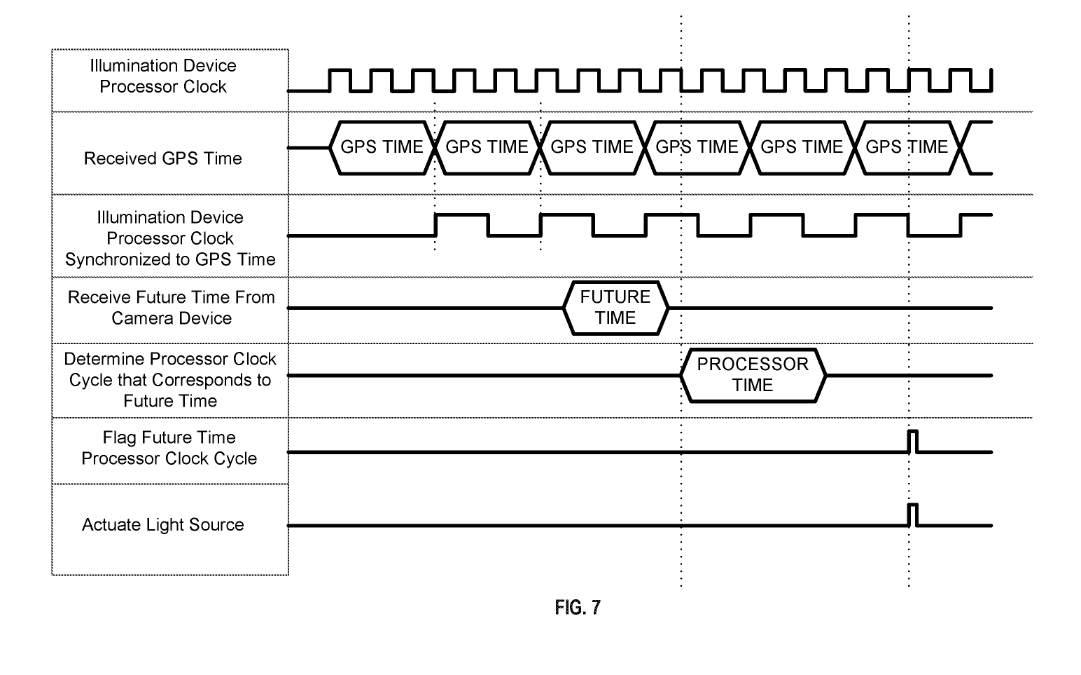

FIG. 7 is a timing diagram that illustrates an example of timing processes of the flash 200, according to some embodiments. The first row is representative of the processor 220 (of flash 200) clock cycle. The processor 220 clock cycle may be a signal that oscillates between an high and a low state that can coordinate actions of the flash 200. The clock signal may be produced by a clock generator such as a quartz piezo-electric oscillator. Although more complex arrangements may also be used, the clock signal may be in the form of a square wave with a 50% duty cycle with a fixed frequency. Circuits using the clock signal for synchronization may become active at either the rising edge, falling edge, or, in the case of double data rate, both in the rising and in the falling edges of the clock cycle. Such circuits may include the light source 210, the main memory 250, the transceiver circuit 240, the COMM module 225, the GPS receiver 230, the external memory 235, and other circuits available on the flash 200.

Still referring to FIG. 7, the second row represents received GPS times. The GPS signal 110 (FIG. 2) is received in five sets of sub-frames. Information indicating the GPS time is included in each sub-frame. Receipt and interpretation of the GPS time from the GPS signal 110 may require more than one flash processor 220 clock cycle. The third row is representative of another processor 220 clock cycle of a flash that is synchronized with the received GPS time. For example, if each successive frame of GPS time received indicates a GPS time incremented by steps of 30 nanoseconds, the flash 200 processor 220 may generate a GPS clock where one clock cycle is completed in 30 nanoseconds. The flash processor 220 may adaptively adjust the GPS clock cycle based on the received GPS time to correct for any errors by storing previously received GPS times in the main memory 250 or the external memory 235 and comparing the previously received GPS times with GPS times received later to determine if the GPS clock cycle is accurate.

Still referring to FIG. 7, the fourth row is representative of receiving a future time message transmitted from the camera 300. The COMM module 225 of the flash 200 may interpret the received message and send the future time to the processor 220. The future time being a time in which the flash 200 actuates the light source 210. It should be noted that the camera 300 may determine two separate future times: (1) a future time in which to capture the image, and (2) a future time in which the light source 210 should illuminate the scene 130. In the case of multiple future times, the camera 300 may only transmit the time in which the flash 200 should activate the light source 210. The fifth row represents a determination by the flash processor 220 of a GPS time that corresponds to an flash processor 220 clock cycle. The sixth row represents a flagged processor or GPS time clock cycle that will trigger actuation of the light source 210 (see row seven).

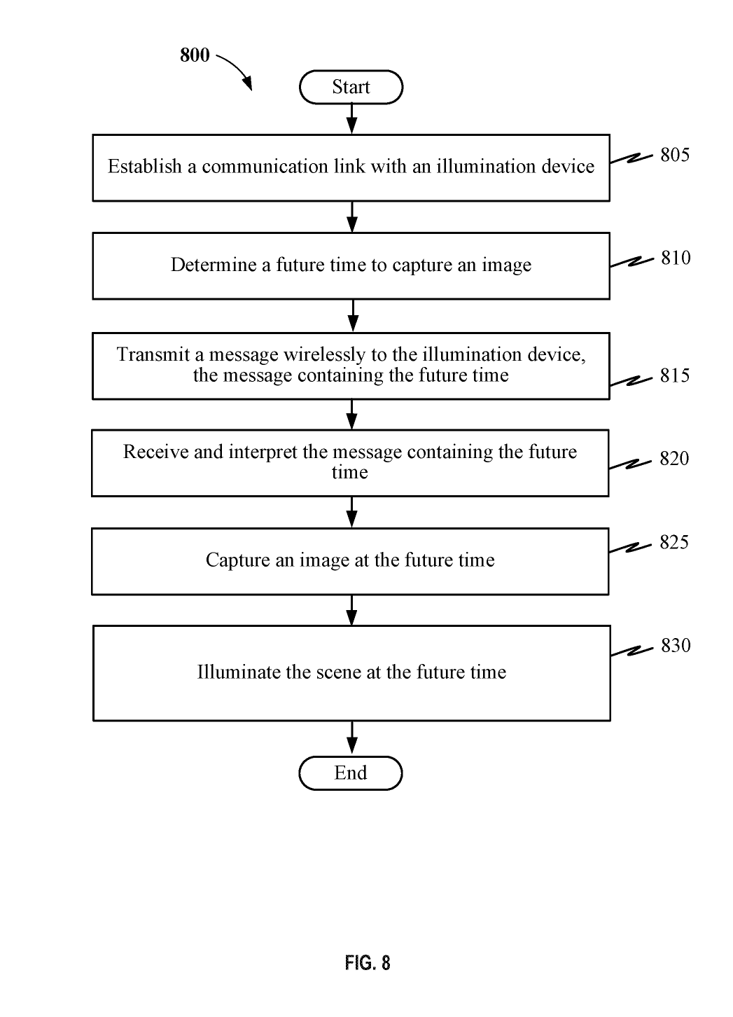

FIG. 8 is a flow chart illustrating an example of a method (or process) for capturing an image of a scene using the camera 300 and the flash 200 described herein. or timing of an example embodiment of the camera 300 and flash 200 system. In this method, although blocks 805, 810, and 815 generally refer to the process that is performed by the camera 300, and blocks 820, 825, and 830 generally refer to the process that is performed by a flash 200. However, it should be appreciated that this disclosure teaches that in block 805 when the camera 300 establishes a communication link with a flash (or illumination device) 200, both the camera 300 and the flash 200 are involved in such a communication. When the system (flash and camera) is described as a whole, the process of both the camera 300 and the flash 200 are considered as part of the process. Such disclosure also teaches that a process of the camera 300 or the flash 200 may be considered separately for the process that is performed on the particular camera or flash device.

In block 805, the camera 300 and the flash 200 establish a communication link 115. The link may be established using RF wireless connectivity technologies including, but not limited to, Wi-Fi, Li-Fi, Zigbee, Bluetooth, Zwave, or cellular connections. The link may also be an IR link. In one embodiment, an RF link may be a Bluetooth or wireless local area network where a wireless network is formed between the flash 200 and the camera 300. Such a network may be formed by pairing two or more devices. So long as both devices are properly paired, a wireless link can be established between the flash 200 and the camera 300. Proper pairing may require that the two devices be in proximity to each other. Here, the proximity requirement provides security with respect to pairing such that unauthorized intruders are not able to pair with another device unless they can be physically proximate thereto. The proximity requirement can also be satisfied by having the devices be directly connected. The COMM module may determine whether the proximity requirement is met by entering a discovery mode or by wirelessly transmitting inquiries. Once the devices are within close proximity, the COMM module of either device may transmit or receive inquiries, or enter into a discovery mode.

Still referring to FIG. 8, once discovered, the COMM modules of both devices may enter into a pairing process. For example, a pairing process typically includes the exchange of cryptographic keys or other data that are utilized to authenticate the devices to one another as well as to encrypt data being transferred between the flash 200 and the camera 300. The pairing of one or both of the devices can be optionally configured for subsequent operation. For example, the COMM modules of the devices can control settings, conditions or descriptions of the other device. Specific examples can include device/user names, passwords, and user settings. Once the devices are paired and appropriately configured, subsequent data transfer can be achieved between the devices.

As illustrated in FIG. 8, in block 810, a user of the camera 300 activates the shutter release to capture an image of the scene 130. Activation of the shutter release may be done by pressing a physical button or a switch, or by pressing a virtual representation of a button or switch, for example, an graphical user interface on a touch screen device. In block 810, the camera processor 320 may determine a time in the future at which the processor 320 will activate the photo assembly 310 and capture an image of the scene 130. In determining this image capture time, the processor 320 may evaluate several parameters including, but not limited to, time required to complete an auto focus function, latency time caused by wireless communication between the camera 300 and the flash 200, and time required to execute a software interrupt to capture the image.

Still referring to FIG. 8, an auto focus algorithm may require time to determine a lens position that will provide a sharp image of the scene. Typically, an auto focus algorithm will evaluate a number of images captured at different lens positions and determine which position provides the sharpest image. For example, in most digital cameras, an auto focus mechanism requires both software execution and an electromechanical operation where a camera motor moves a lens into several positions before the processor determines the best lens position for the scene 130 being captured. The processor may wait until the auto focus mechanism completes before determining the image capture time, or it may estimate the amount of time required for the auto focus mechanism to complete and use this estimation to determine the future image capture time. In some instances, the processor 320 may be running software in parallel with software associated with camera operation. In this situation, the processor 320 will have to determine a time to interrupt the software to activate the photo assembly 310. Using the processor's 320 internal clock cycle, the processor 320 may determine a future clock cycle at which to execute the software interrupt.

Still referring to FIG. 8, the camera processor 320 may synchronize its internal clock system to the time received by the GPS receiver 330. In one example, the processor 320 receives a series of packets, the series of packets containing GPS reported times from the GPS receiver 330 in a sequential order. The processor may determine the number of clock cycles that have elapsed between the two reported times and equate that number of clock cycles to the duration of time reported passed between the two sequential GPS times. The processor may record the GPS time duration and the number of clock cycles associated with that duration in the main memory 350. The camera processor 320 may continue to receive subsequent GPS reported times from the GPS receiver 330 and determine the number of clock cycles between each reported time. The processor 320 may further compare the number of clock cycles for each duration to the number of clock cycles recorded for previous durations. In this way, the processor can perform maintenance on how it tracks the time from the GPS receiver. For example, if the internal processor determines that 60 clock cycles have elapsed between two sequentially received GPS times with a 10 ns duration of time reported between them, the camera processor 320 may record this information in the main memory 350 and equate 60 clock cycles to 10 ns of GPS time. In this way, the camera processor 320 may determine an equivalent future GPS time to a future clock cycle at which the photo assembly 310 may capture an image of the scene 130.

After evaluation of the parameters and synchronizing the GPS time with the processor 320 clock cycle, the processor 320 may determine a future image capture time. For example, the processor 320 may determine that the auto focus mechanism will be complete and that a software interrupt can be executed at a specific clock cycle in the future. At this specific clock cycle, the camera 300 will capture an image of the scene 130. The camera processor 320 may use the GPS receiver to determine a GPS time that corresponds to the specific clock cycle in the future. The processor 320 and COMM module 325 may create a message containing the image capture time, in a GPS time format, for wireless transmission to the flash 200.

Again referring to FIG. 8, in block 815, the camera 300 transmits the message containing the image capture time for wireless transmission to the flash 200. The message may be transmitted using the COMM module 325 and transceiver circuit 340 over a wireless connection. The COMM module 325 may format the message in order to be compliant with protocols associated with the wireless connectivity technology used for communication between the camera 300 and the flash 200. For example, in a Bluetooth communication setting, the message is sent to the flash 200 via the Bluetooth wireless connection set up by the cooperation of the camera 300 COMM module 325 and the flash 200 COMM module 225 (in this example, both COMM modules are a Bluetooth module).

In block 820, the flash 200 receives the wirelessly transmitted message containing the image capture time via the transceiver circuit 240 and the COMM module 225. The COMM module 225 can interpret the message and determine the future time. The COMM module 225 may then communicate the image capture time to the processor 220 of the flash 200. The flash processor 220 may then determine a future clock cycle that coincides with the received future time.

In block 825, the flash 200 actuates the light source at the future time. In block 830, the camera system 300 captures an image of the scene at the same future time. Because the GPS receivers of both the flash 200 and the camera 300 receive the same GPS time frames from the GPS satellite 105, both the camera 300 and the flash 200 may be able to independently activate in sync at the future time.

Still referring to FIG. 8, in order to determine the future clock cycle, the flash processor 220 may synchronize its internal clock system to the time received by the GPS receiver 230. In one example, the processor 220 receives two sequential GPS reported times from the GPS receiver 230. The processor may determine the number of clock cycles that have elapsed between the two reported times and equate that number of clock cycles to the duration of time reported passed between the two sequential GPS times. The processor may record the GPS time duration and the number of clock cycles associated with that duration in the main memory 250. The processor 220 may continue to receive subsequent GPS reported times from the GPS receiver 230 and determine the number of clock cycles between each reported time. The processor 220 may further compare the number of clock cycles for each duration to the number of clock cycles recorded for previous durations. In this way, the processor can perform maintenance on how it tracks the time from the GPS receiver. For example, if the internal processor determines that 60 clock cycles have elapsed between two sequentially received GPS times with a 10 ns duration of time reported between them, the flash processor 220 may record this information in the main memory 250 and equate 60 clock cycles to 10 ns of GPS time. In this way, the flash 200 processor 220 may determine an equivalent future GPS time to a future clock cycle at which the light source 210 may be activated to illuminate the scene 130.

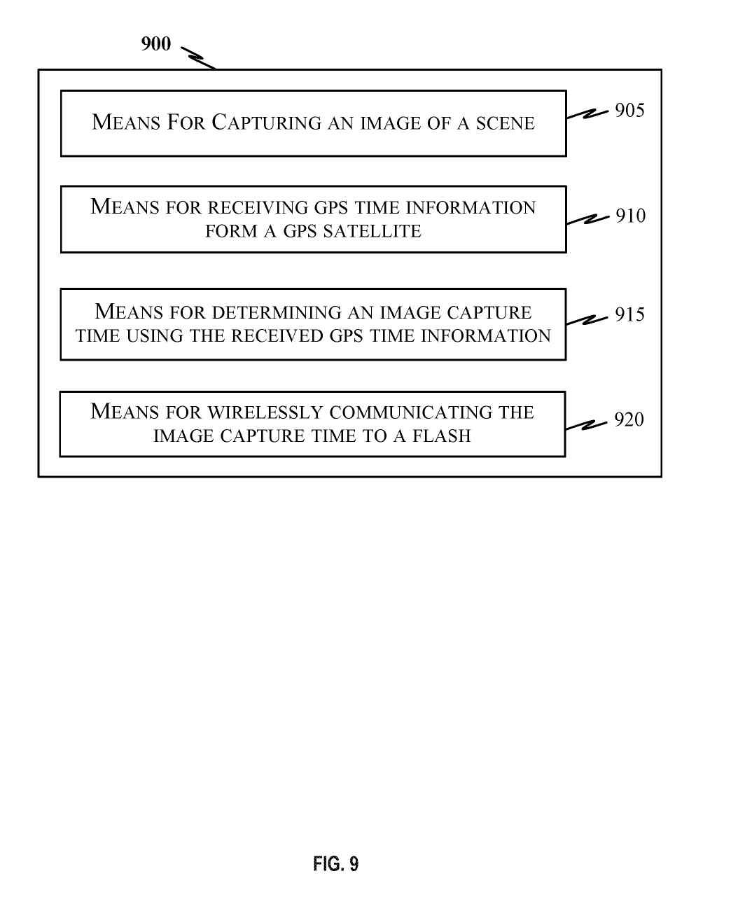

FIG. 9 is a block diagram illustrating an example of an apparatus 800 for generating an image capture time that occurs in the future (also referred to as “future time”) and transmitting that time to an flash 200 so that the flash 200 and the apparatus 900 may operate in a synchronous manner. The apparatus 900 may include means 905 for capturing an image of a scene 130 at an image capture time. In some implementations, the capturing means 905 may be a camera 300. The apparatus 900 may include a means 910 for receiving a frame containing GPS time information from a GPS satellite 105. In some implementations, the receiving means 910 may be a GPS receiver 330 illustrated in FIG. 4. The apparatus 900 may include means 915 for determining an image capture time that occurs at a point in time in the future based on the received GPS time information. In some implementations, the determining means 915 may be a processor 320 illustrated in FIG. 3. The apparatus 900 may include means 920 for wirelessly communicating the image capture time to the flash 200. In some implementations, the communicating means 920 may be a transceiver circuit 240 in the flash 200 (FIG. 2) or the transceiver circuit 340 in camera 300 (FIG. 3).

### Implementing Systems and Terminology

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

The terms “illumination device” and “flash” are broad terms used herein to describe a system providing illumination on an object or for a scene, and includes a light source, for example, a light-emitting-diode structure, an array of light-emitting-diodes, a lamp structure, a gas-filled flash bulb, or any other type of light source suitable for providing illumination when capturing images with camera.

The term “Global Positioning System” or GPS is a broad term and is used herein to describe a space-based system that provides location and time information. Such systems may include the Naystar system, Galileo, Glonass, Beidou, and other systems. The term “global navigation satellite system” or GNSS is used herein to describe the same.

The term “shutter release” is a broad term and is used herein to describe a physical or virtual button (for example, a touch screen display presenting a graphical user interface) or switch that is actuated by a user in order to capture an image with an imaging device. Such imaging devices include cameras and other portable devices with image capturing systems incorporated in them (for example, tablets, smartphones, laptops, and other portable devices with an imaging system). The shutter release may activate a camera shutter or it may activate a set of instructions on a processor that enable an image sensor to capture an image of a scene.

The term “software interrupt” is a broad term and is used herein to describe a signal to the processor emitted by hardware or software indicating an event that needs immediate attention. The software interrupt alerts the processor to a high-priority condition requiring the interruption of code the processor is currently executing.

The term “camera” is a broad term and is used herein to describe an optical instrument for recording images, which may be stored locally, transmitted to another location, or both. The images may be individual still photographs or a sequences of images constituting videos or movies.

The term “flash” is a broad term and is used herein to describe a device that provides a source of light when a user directs a camera to acquire an image or images. When illumination on a scene is desired, the source of light may be directed to produce light by control circuitry. The source of light may be a light-emitting-diode, an array of light-emitting-diodes, a lamp, or other camera flash.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal®, or Java®, and ran under a conventional operating system. C, C++, BASIC, Pascal, Java®, and FORTRAN are industry standard programming languages for which many commercial compilers can be used to create executable code. The system may also be written using interpreted languages such as Perl®, Python®, or Ruby.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A system, comprising:
a camera comprising
an image sensor;
a global positioning system (GPS) receiver configured to receive time information from a GPS satellite;
a processor configured to determine an image capture time t₁ for capturing the image of a scene, the image capture time t₁ derived from time information received from the GPS satellite; and
a camera communication module configured to wirelessly communicate with an illumination system to transmit flash information to the illumination system, the flash information including the image capture time t₁,
wherein the processor is further configured to capture an image of the scene with the camera at the image capture time t₁.

2. The system of claim 1, further comprising the illumination system, the illumination system comprising:
a light source;
a GPS receiver configured to receive time information from a GPS satellite;
a communication module configured to wirelessly communicate with the camera to receive the flash information including the image capture time t₁;
a processor configured to activate the light source at the image capture time t₁ and to use time information received from a GPS satellite to determine when the image capture time t₁ occurs.

3. The system of claim 1, wherein the camera communication module is further configured to receive an acknowledgment message from the illumination system.

4. The system of claim 3, wherein the acknowledgment message provides at least one of:
a signal indicating acceptance of the image capture time,
a signal indicating a time the illumination device received the flash information, or
a signal indicating denial of the image capture time.

5. The system of claim 3, wherein the acknowledgement message indicates a denial of the image capture time t₁ and a reason for the denial of the image capture time t₁.

6. The system of claim 1, wherein the processor is configured to determine the image capture time t₁ by including a latency time period indicating a length of time elapsed between generating the flash information by the camera and the receipt of the flash information by the illumination device.

7. The system of claim 6, wherein the latency time period is determined based on at least one of:
a time that a software interrupt can occur as determined by the processor, or
a communication delay between the camera system and the flash.

8. The system of claim 1, wherein the flash information includes a time indicating when the camera transmitted the flash information.

9. The system of claim 1, wherein the processor is further configured to generate a GPS clock cycle for tracking image capture time t₁, wherein one cycle of the GPS clock cycle is equivalent to an interval of time, the interval of time calculated using a time differential between two or more successive times received via the time information.

10. A method for illuminating and capturing an image of a scene using a camera device, the camera device wirelessly paired to a flash for wireless communication, comprising:
receiving a frame of time information via a global positioning system (GPS) receiver, the frame of time information transmitted from a GPS satellite;
determining an image capture time for capturing an image of a scene, the image capture time based on the received time information;
transmitting a first message to the flash, the first message comprising the image capture time; and
capturing the image of the image of the scene at the image capture time.

11. The method of claim 10, further comprising the flash, the flash comprising:
receiving the frame of time information via the GPS receiver, the frame of time information transmitted from the GPS satellite;
receiving the flash information including the image capture time t₁ from the camera device;
activating a light source at the image capture time t₁ and using time information received from the GPS satellite to determine when the image capture time t₁ occurs.

12. The method of claim 10, wherein the camera device is further configured to receive an acknowledgment message from the flash.

13. The method of claim 12, wherein the acknowledgment message provides at least one of:
a signal indicating acceptance of the image capture time t₁,
a signal indicating a time the illumination device received the flash information, or
a signal indicating denial of the image capture time.

14. The method of claim 12, wherein the acknowledgement message indicates a denial of the image capture time t₁ and a reason for the denial of the image capture time t₁.

15. The method of claim 11, wherein determining the image capture time t₁ includes a latency time period, wherein the latency time period indicates a length of time elapsed between generation of the flash information by the camera and the receipt of the flash information by the illumination device.

16. The method of claim 15, wherein the latency time period is determined based on at least one of:
a time that a software interrupt can occur as determined by a processor, or
a communication delay between the camera system and the flash.

17. A system for capturing an image of a scene, comprising:
means for capturing the image of the scene at an image capture time;
means for illuminating the scene, wherein the means for illuminating is wirelessly paired to the means for capturing the image;
means for receiving a frame of time information transmitted from a global positioning system (GPS) satellite;
means for determining the image capture time based on the received time information; and
means for transmitting a first message to the means for illuminating, the first message comprising the image capture time.

18. The system of claim 17, wherein the means for illuminating further comprises:
means for receiving the frame of time information transmitted from the GPS satellite;
means for receiving the image capture time t₁;
means for activating a light source at the image capture time t₁ and using time information received from the GPS satellite to determine when the image capture time t₁ occurs.

19. The system of claim 17, wherein determining the image capture time t₁ includes a latency time period, wherein the latency time period indicates a length of time elapsed between generation of the flash information by the camera and the receipt of the flash information by the illumination device.

20. The system of claim 19, wherein the latency time period is determined based on at least one of:
a time that a software interrupt can occur as determined by a processor, or
a communication delay between the camera system and the flash.
